(19) United States
(12) Patent Application Publication
(10) Pub. No.: US 2016/0010255 A1
(43) Pub. Date: Jan. 14, 2016

(54) APPARATUS AND METHODS FOR FLUID FILTRATION

(71) Applicant: John H. Kelleher, Long Beach, CA (US)

(72) Inventor: John H. Kelleher, Long Beach, CA (US)

(21) Appl. No.: 14/798,043

(22) Filed: Jul. 13, 2015

Related U.S. Application Data
(60) Provisional application No. 62/024,042, filed on Jul. 14, 2014.

(51) Int. Cl. D06B 23/20; B01D 35/30; B01D 29/58

(52) U.S. Cl. CPC D06B 23/20; B01D 29/58; B01D 35/306

(57) ABSTRACT

A fluid filtration cartridge assembly includes an outer mesh wall and an inner mesh wall defining a space therebetween; a plurality of partitions extending between the outer wall and the inner wall, thereby dividing the space into a plurality of compartments; a filter surrounding the outer mesh wall; and a filter packet removal implement removably installed in at least one of the compartments, the filter packet removal implement including a plate disposed in the at least one compartment and a handle attached to the plate. The implement is configured to facilitate the removal of a filter packet loaded into the compartment and seated on the plate.

### CROSS-REFERENCE TO RELATED APPLICATION

This application claims priority, under 35 U.S.C. §119(e), from US Provisional Application No. 62/024,042; filed Jul. 14, 2014, the disclosure of which is incorporated herein by reference in its entirety.

### FEDERAL SPONSORED RESEARCH OR DEVELOPMENT

Not Applicable

### BACKGROUND

The present embodiments relate to fluid filtration, in particular to filtration of liquids and solvents used in the textile cleaning industry.

In the textile cleaning industry, filter cartridges are typically used to remove dirt and other particles from liquids and solvents. The inside of a typical filter cartridge includes filter powder(s) and carbon, which are loose within the cartridge. These filter cartridges are typically sealed, and therefore are not amenable to being disassembled. For example, current cartridges typically have end caps that are glued to a pleated paper filter contained within the cartridge. The filter powder (which may also include clay and/or granules) is contained between the glued end caps. When the filter reaches the end of its usability, neither the pleated paper nor the enclosed filter powder can be replaced. Thus, when a sealed filter cartridge reaches the end of its lifecycle, it is disposed of in its entirety and replaced with a new cartridge. Spent filter cartridges retain large quantities of solvents, water, NVRs (non-volatile residues), dyes, dirt particles, and detergent particles. Thus, disposing of spent cartridges results in these retained substances entering the waste stream, which is wasteful, and which increases disposal costs and detrimentally impacts the environment.

### SUMMARY

Broadly, this disclosure relates to an apparatus for fluid filtration, comprising an outer wall and an inner wall defining a space therebetween; a plurality of partitions extending between the outer wall and the inner wall, thereby subdividing the space into a plurality of compartments; and a filter packet located within at least one of the compartments. A filter packet removal implement, employed with some embodiments, is configured to be installed in at least one of the compartments. The filter packet removal implement comprises a plate on which the filter packet may be seated when the filter packet is installed in the compartment, and a handle fixed to the plate so as to extend out of the compartment, whereby the filter packet can be removed from the compartment when the implement is pulled out of the compartment using the handle.

### BRIEF DESCRIPTION OF THE DRAWINGS

FIG. 1 is a top plan view of an end cap for a fluid filtration apparatus according to the present embodiments;

FIG. 2 is a side perspective view of an outer partition for a fluid filtration apparatus according to the present embodiments;

FIG. 2A is a detail view of the portion of FIG. 2 indicated by the box 2A-2A in FIG. 2;

FIG. 3 is a side perspective view of an assembly according to the present embodiments, including the end cap of FIG. 1 and the outer partition of FIG. 2;

FIG. 4 is a side perspective view of an inner partition for a fluid filtration apparatus according to the present embodiments;

FIG. 5 is a side perspective view of an assembly according to the present embodiments, including the assembly of FIG. 3 and the inner partition of FIG. 4;

FIG. 6 is a side perspective view of an assembly according to the present embodiments, including the assembly of FIG. 5 and a plurality of radial partitions;

FIG. 7 is a top perspective view of the assembly of FIG. 6;

FIG. 8 is a side perspective view of an annular, pleated filter configured for use with the present embodiments;

FIG. 9 is a side perspective view of an assembly according to the present embodiments, including the assembly of FIG. 6 and the annular filter of FIG. 8;

FIG. 10 is a side perspective view of an assembly according to the present embodiments, including the assembly of FIG. 9 and a plurality of sealed filter packets;

FIG. 11 is a filter cartridge for a fluid filtration apparatus according to the present embodiments, including the assembly of FIG. 9, a plurality of filter packets, and a second end cap;

FIG. 12 is a top plan view of another fluid filtration apparatus according to the present embodiments;

FIG. 13 is a side elevation view of the fluid filtration apparatus of FIG. 12;

FIG. 14 is a side elevation view of one end cap of the fluid filtration apparatus of FIG. 12;

FIGS. 15 and 16 are side elevation views of the fluid filtration apparatus of FIG. 12;

FIG. 17 is a side perspective view of the fluid filtration apparatus of FIG. 12;

FIG. 18 is a perspective view of a filter packet removal implement in accordance with an aspect of the disclosure; and

FIG. 19 is a perspective view of a fluid filtration apparatus in accordance with an embodiment of the disclosure, in which the filter packet removal implement of FIG. 18 has been installed.

### DETAILED DESCRIPTION

The present embodiments provide a cartridge filtration apparatus and associated methods configured for use in the textile cleaning industry. Embodiments of the present cartridge filtration apparatus and methods enhance filtration, reduce waste, lower disposal costs, and reduce the environmental impact of disposing of spent filter cartridges.

The present embodiments are described below with reference to the figures. These figures, and their written descriptions, indicate that certain components of the apparatus are formed integrally, and certain other components are formed as separate pieces. It will be appreciated that components shown and described herein as being formed integrally may be formed as separate pieces, and that components shown and described herein as being formed as separate pieces may be formed integrally. As used herein, the term “integral” describes a single unitary piece.

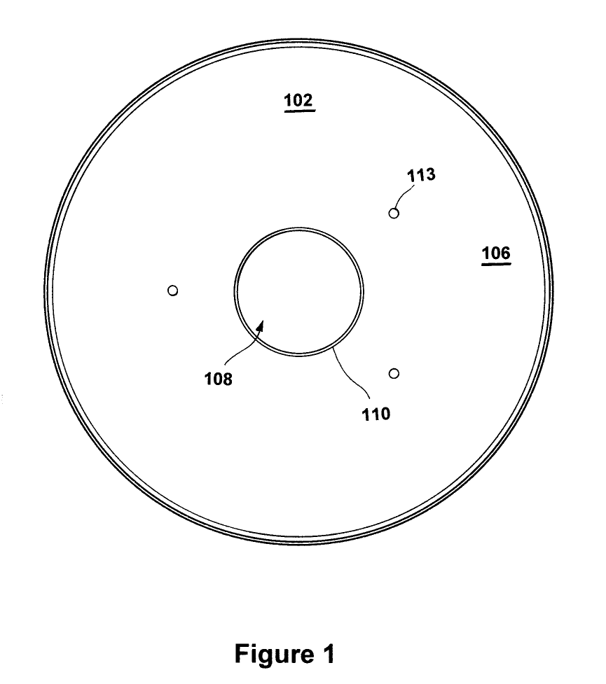

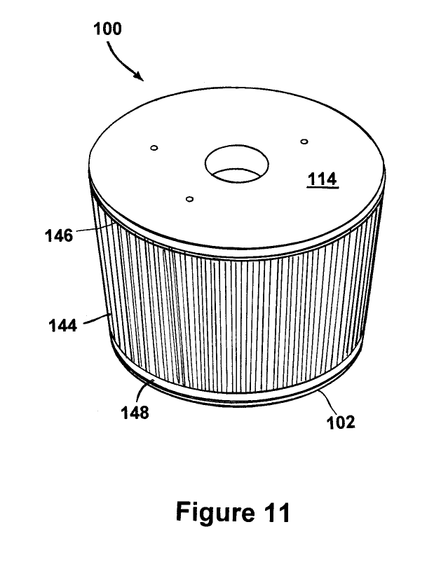

FIGS. 1-11 illustrate one embodiment of an apparatus 100 (also referred to as a filter cartridge 100, shown in FIG. 11) for fluid filtration. With reference to FIGS. 1-3, the apparatus 100 comprises a first end cap 102 and an outer wall 104. The first end cap 102 includes a body portion 106 shaped substantially as a flat, annular disk defining a central opening 108. An inner annular flange 110 extends perpendicularly to the body portion 106 around the central opening 108. An outer annular lip 112 extends perpendicularly to the body portion 106 around the periphery of the first end cap 102. The body portion 106 includes a plurality of apertures 113 configured to receive fastening members (not shown) to secure the first end cap 102 to the apparatus 100, as discussed below. The apparatus 100 further comprises a second end cap 114 (FIG. 11) that may be substantially identical to the first end cap 102 and disposed opposite the first end cap 102 in the assembled apparatus 100, as further described below.

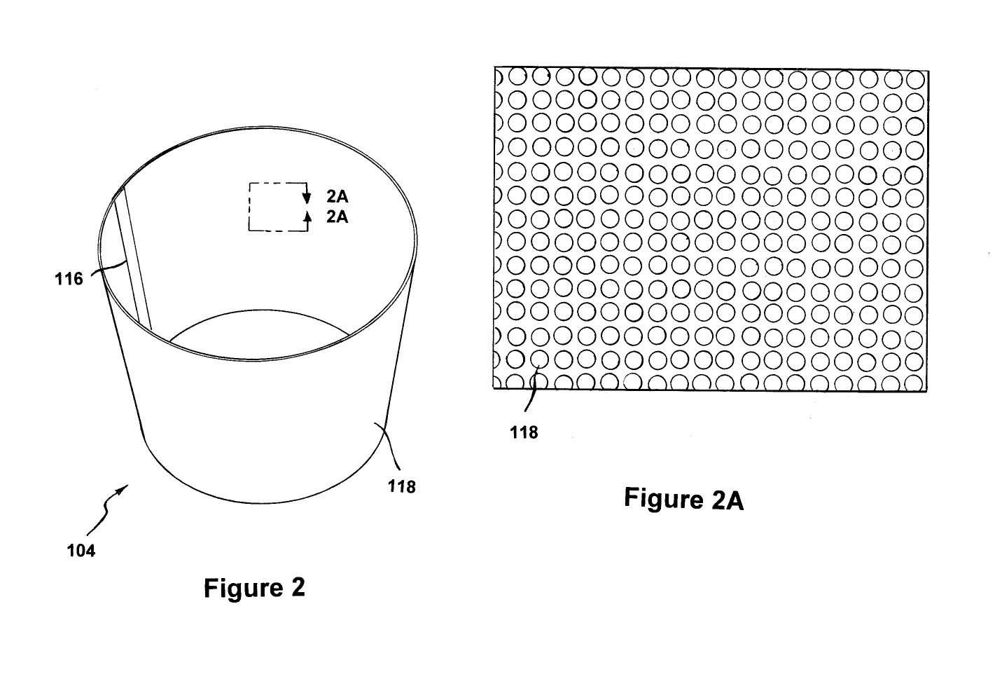

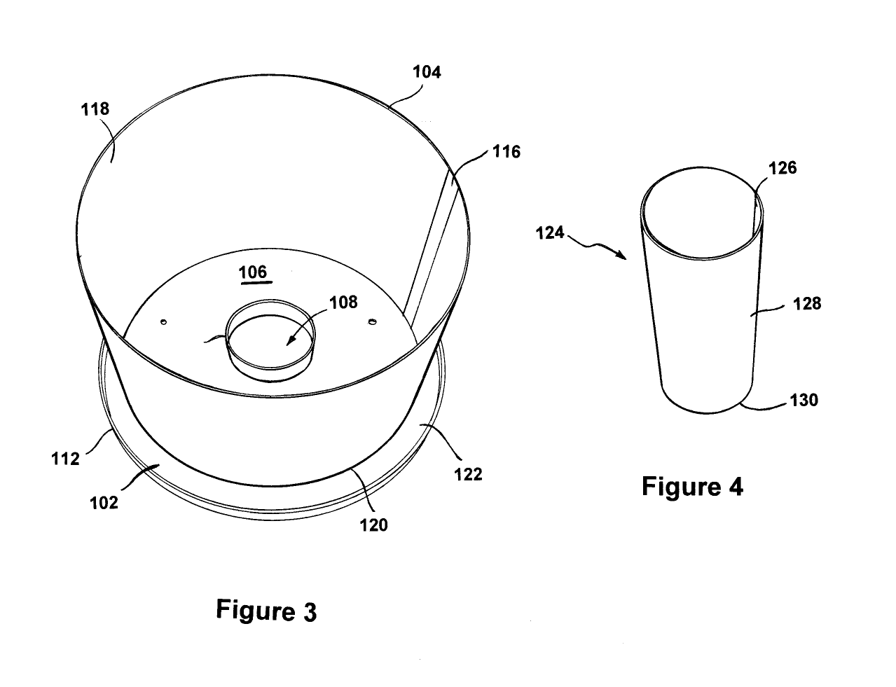

With reference to FIGS. 2, 2A, and 3, the outer wall 104 comprises a first or outer cylindrical screen of a mesh or mesh-like material. The outer wall 104 may be formed from a rectangular sheet of mesh or mesh-like material rolled into a cylinder with opposite edges of the rectangular sheet fastened together at a seam 116. As best shown in FIG. 2A, the mesh or mesh-like material includes a plurality of regularly spaced openings 118 that allow fluid to pass through the outer wall 104 in either direction. In certain embodiments, the outer wall 104 may comprise about fifteen openings 118 per linear inch, such as between about five openings 118 per linear inch and about twenty-five openings 118 per linear inch. The outer wall 104 may have the same number of openings 118 per linear inch in both the x and y directions, or it may have more openings 118 per linear inch in one or the other direction. With reference to FIG. 3, a first end 120 of the outer wall 104 abuts an inner surface 122 of the first end cap 102. A diameter of the outer wall 104 is such that the outer wall 104 occupies a space 132 between the inner annular flange 110 and the outer annular lip 112 of the first end cap 102.

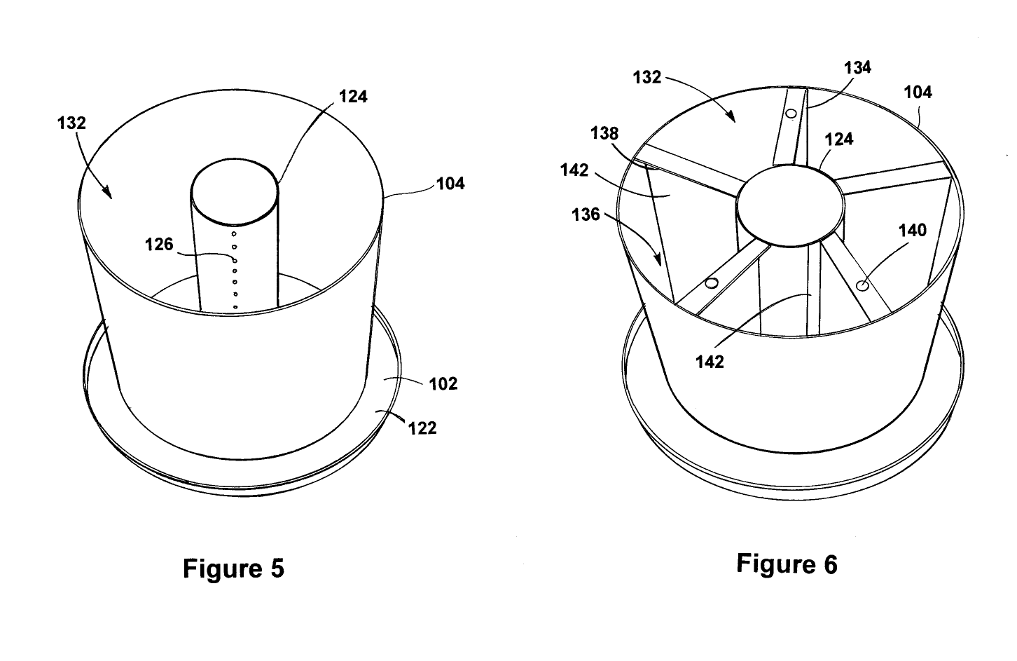

With reference to FIGS. 4 and 5, the apparatus 100 further comprises an inner wall 124 that comprises a second or inner cylindrical screen of a mesh or mesh-like material. The inner wall 124 may be formed from a rectangular sheet of mesh or mesh-like material rolled into a cylinder with opposite edges of the rectangular sheet fastened together at a seam 126. The mesh or mesh-like material includes a plurality of regularly spaced openings 128 (FIG. 4) that allow fluid to pass through the inner wall 124 in either direction. In some embodiments, the outer and inner walls 104, 124 may be constructed of the same material, and may, therefore, have common characteristics, such as the same number of openings 118, 128 per linear inch. In other embodiments, the outer and inner walls 104, 124 may be constructed of different materials, and may, therefore, have different characteristics, such as different numbers of openings 118, 128 per linear inch.

With reference to FIG. 5, a first end 130 (FIG. 4) of the inner wall 124 abuts the inner surface 122 of the first end cap 102. A diameter of the inner wall 124 is such that the inner wall 124 extends around the inner annular flange 110. The diameter of the inner wall 124 may be such that the inner surface of the inner wall 124 abuts the outer surface of the inner annular flange 110.

With continued reference to FIG. 5, the outer wall 104 and the inner wall 124 define the outer and inner boundaries, respectively, of a space 132 formed between the outer wall 104 and the inner wall 124. In the illustrated embodiment, the space 132 between the outer wall 104 and the inner wall 124 is annular. However, the illustrated shapes for the outer wall 104, the inner wall 124, and the space 132 are not limiting. Any or all of the outer wall 104, the inner wall 124, and the space 132 between the outer wall 104 and the inner wall 124 may have a shape other than as shown.

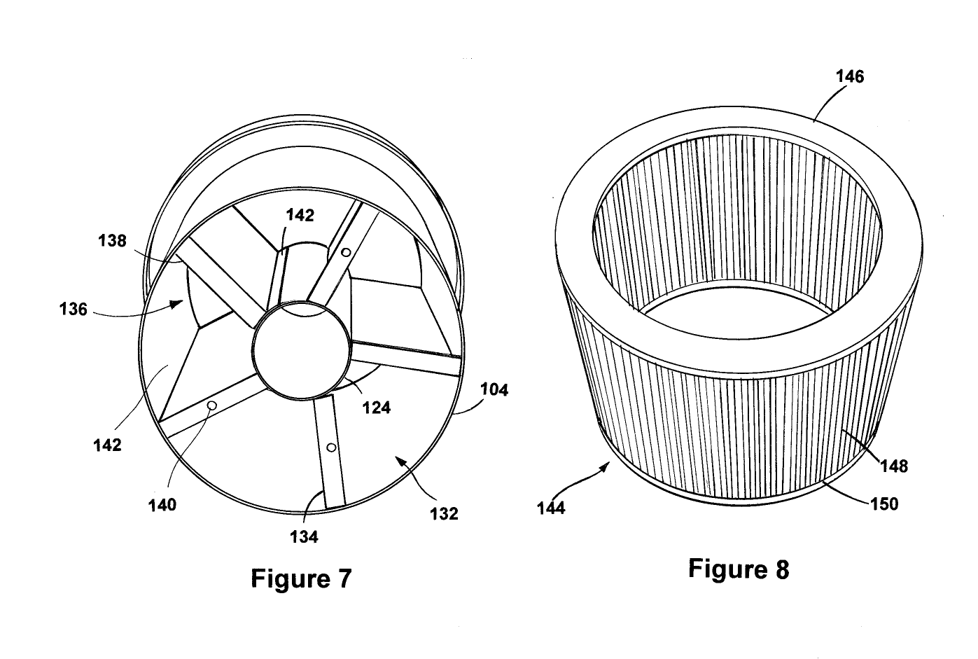

With reference to FIGS. 6 and 7, the apparatus 100 further comprises a plurality of partitions 134 extending between the outer wall 104 and the inner wall 124. The partitions 134 divide the space 132 between the outer wall 104 and the inner wall 124 into a plurality of longitudinally-extending radial segments, each of which defines a discrete filter medium compartment 136. In the illustrated embodiment, each of the partitions 134 extends in a radial direction between the outer wall 104 and the inner wall 124. However, the illustrated configuration for the partitions 134 is not limiting. Also in the illustrated embodiment, five partitions 134 are shown dividing the space 132 between the outer wall 104 and the inner wall 124 into five longitudinal compartments 136. However, the illustrated number of partitions, 134 and thus compartments 136, is not limiting; the number and configuration of the partitions 134 may provide any desired number of compartments 136.

Each partition 134 is shaped substantially as a flat rectangular sheet. However, opposite edges of each partition 134 include flanges 138 that extend generally perpendicularly with respect to a plane defined by each partition 134. The flanges 138 are configured to abut inner surfaces of the first and second end caps 102, 114. Some or all of the flanges 138 may include apertures 140. The end caps 102, 114 include corresponding apertures 113 (FIG. 1) that, when aligned with the apertures 140 in the flanges 138, are adapted to receive fastening members (not shown) to removably secure the end caps 102, 114 to either end of the assembled apparatus 100. The fastening members may comprise, for example, bolts or screws.

The partitions 134 may be secured to one or both of the outer wall 104 and the inner wall 124. For example, edges of the partitions 134 that extend along the outer wall 104 and the inner wall 124 may also include flanges 142 configured to receive fastening members to secure the partitions 134 to the outer wall 104 and/or the inner wall 124. Alternatively, or in addition, the partitions 134 may be secured to one or both of the outer wall 104 and the inner wall 124 by more permanent means, such as welding.

With reference to FIG. 8, the apparatus 100 further comprises a cylindrical filter 144, preferably configured with longitudinal pleats or folds. The filter 144 comprises first and second ring-shaped end plates 146, 148 with pleated paper or fabric 150 sandwiched between the end plates 146, 148. In some embodiments, the pleated paper or fabric 150 may comprise polyester or nylon, for example. In some embodiments, the filter 144 may comprise a commercially-available, off-the-shelf component. With reference to FIGS. 9 and 11, the filter 144 is received within the assembled apparatus 100 such that the filter 144 extends around the outer wall 104, and the end plates 146, 148 of the filter 144 abut the end caps 102, 114 of the apparatus 100 (FIG. 11).

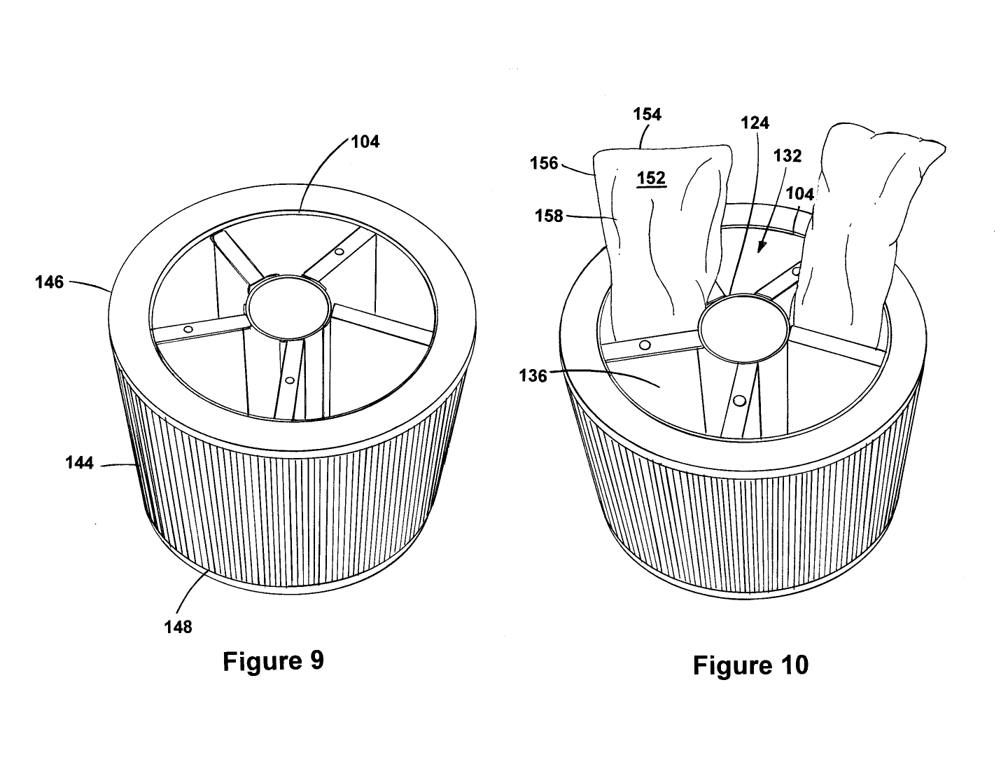

With reference to FIG. 10, the apparatus 100 further comprises a filter medium contained in one or more of the compartments 136 of the space 132. In some embodiments, the filter medium (not shown separately) may be bulk-filled or loose-filled into the compartments 136. In other embodiments, the filter medium is advantageously contained within a filter packet 152 that is removably installed in at least one of the compartments 136. In some embodiments, a single filter packet 152 is removably installed in each of the compartments 136, while in other embodiments, one or more of the compartments 136 may contain no filter packet 152. In some embodiments, at least one of the compartments 136 may be configured to contain more than one filter packet 152. The present embodiments are not limited by any particular distribution of filter packets 152 among the compartments 136 between the outer wall 104 and the inner wall 124. Any and all possible distributions are contemplated within the scope of the present embodiments.

Each of the filter packets 152 advantageously comprises a casing 154 containing a filter medium (not shown), which may be in the form of a powder, granules, clays, and/or other solvent purifying substances. Suitable filter media for specific applications, such as, for example, dry cleaning, are well-known in the art. The casing 154 may comprise a porous or mesh-like material, such as a fabric, which allows fluid to pass through the packet 152 and the filter medium therein in either direction, but does not allow passage of the filter medium. Non-limiting examples of materials for the casing 154 include cloth, nylon, polyester, paper, etc. and/or combinations thereof. Edges 156 of the casing 154 may include stitching 158 and/or adhesive to seal the edges 156 and prevent the filter medium from escaping the casing 154.

The filter medium contained within the casing 154 preferably comprises one or more powdered or granular materials suitable for absorbing impurities from liquids and/or solvents. For example, the filter medium may be of the type that absorbs NVRs (non-volatile residues), dyes, dirt particles, detergent particles, water, fatty acids, and/or odor-causing bacteria. The filter medium within a single casing 154 may comprise a single material, or it may comprise a mixture of two or more materials. Also in some embodiments, a single filter cartridge 100 may include at least one filter packet 152 containing a first filter medium, and at least one filter packet 152 containing a second filter medium. Further, the present embodiments contemplate any number of filter packets 152, each containing a different filter medium.

FIG. 11 illustrates the assembled filter cartridge apparatus 100 for fluid filtration, including the first and second end caps 102, 114 secured at opposite ends of the apparatus 100. As discussed above, the end caps 102, 114 may be removably secured to the assembly 100 with fastening members (not shown) such as screws or bolts extending through the apertures 113. The fastening members may extend through the apertures 113 in the end caps 102, 114 and the corresponding apertures 140 in the partitions 134.

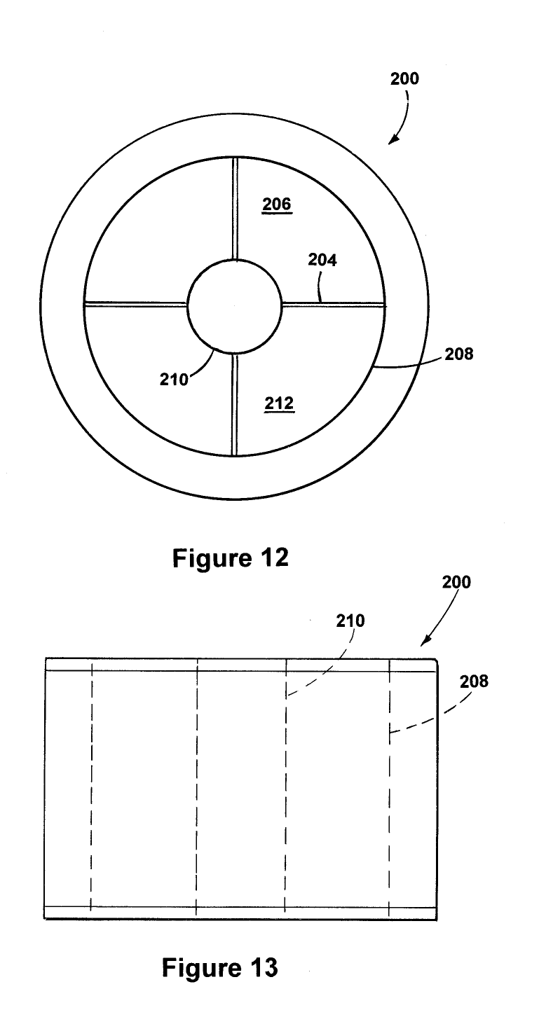

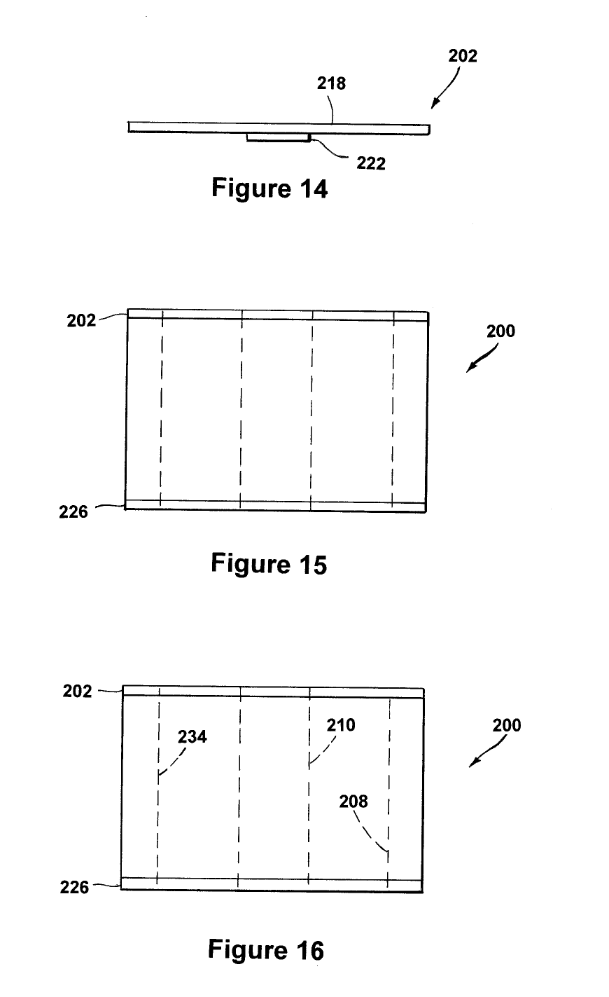

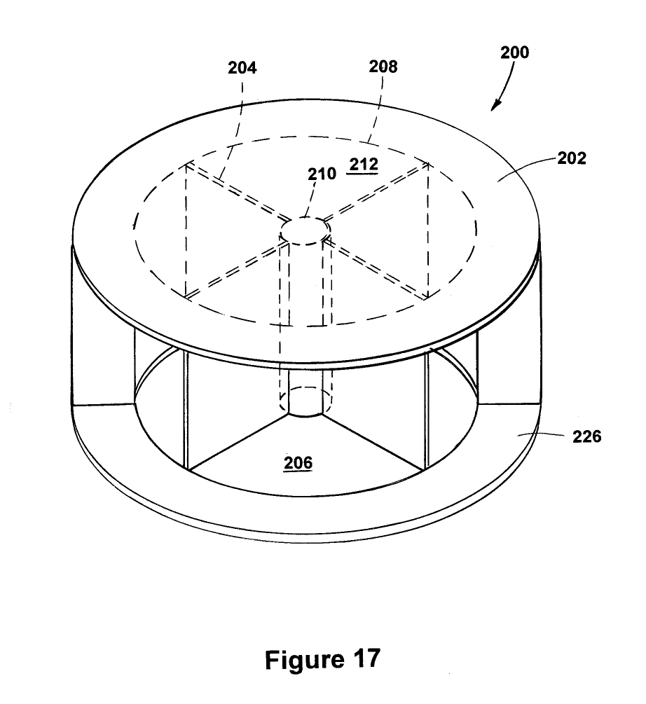

FIGS. 12-17 illustrate another filter cartridge assembly 200 for a fluid filtration apparatus according to the present embodiments. FIG. 12 is a top view, and FIG. 13 is a side view. FIG. 14 is a side view of a first end cap 202 of the filter cartridge assembly 200, while FIGS. 15 and 16 are side views of the filter cartridge assembly 200, and FIG. 17 is a side perspective view of the assembly 200.

The filter cartridge assembly 200 of FIGS. 12-16 is similar to the apparatus 100 shown in FIGS. 1-11 and described above. However, with reference to FIGS. 12 and 17, the assembly 200 includes a plurality of partitions 204 subdividing the space 206 between the outer wall 208 and the inner 210 wall into a corresponding plurality of segments, each of which defines a filter medium compartment 212. While the illustrated embodiment includes four partitions 204 and four compartments 212, any other number of partitions and/or compartments may be suitable in various embodiments.

With reference to FIG. 14, the first end cap 202 includes a substantially planar body portion 218 and an inner annular post 222. The body portion 218 includes a plurality of apertures (not shown) configured to receive fastening members (not shown) to removably secure the first end cap 202 to the partitions 204 in a similar manner to that described above with respect to the assembly shown in FIGS. 1-11. Referring to FIGS. 15 and 16, the filter cartridge assembly 200 further includes a second end cap 226 that includes a plurality of apertures configured to receive fastening members (not shown) to removably secure the second end cap 226 to the partitions 204 in a similar manner to that described above with respect to the assembly shown in FIGS. 1-11. While not shown, the filter cartridge assembly 200 further includes an annular pleated filter, similar to the previously-described filter 144, extending around the outer wall 228 and sandwiched between the end caps 202, 226.

With reference to FIG. 15, the first end cap 202 seats over a first end of the filter cartridge assembly 200 with the inner annular post 222 received within the inner wall 210. Fastening members (not shown) removably secure the first end cap 202 to the partitions 204.

FIGS. 14-16 illustrate exemplary dimensions for the filter cartridge assembly 200. The illustrated dimensions are only one example, and should not be interpreted as limiting the scope of the present filter cartridge assembly 200 in any way. With reference to FIG. 14, the inner annular post 222 of the first end cap 202 may have an outer diameter of 2 13/16″. With reference to FIG. 16, the filter cartridge assembly 200 may have an overall height of 9″. In alternative embodiments, the filter cartridge assembly 200 may have an overall height of up to about 18″, for example. With reference to FIGS. 15 and 16, the inner wall 210 may have a diameter of 3″, the outer wall 208 may have a diameter of 9⅞″, a clearance 234 between the outer wall 228 and the filter may be 1/16″, and an annular space for receiving the filter may have a width of 1½″. With reference to FIG. 15, a thickness of the second end cap 226 may be 7/16″.

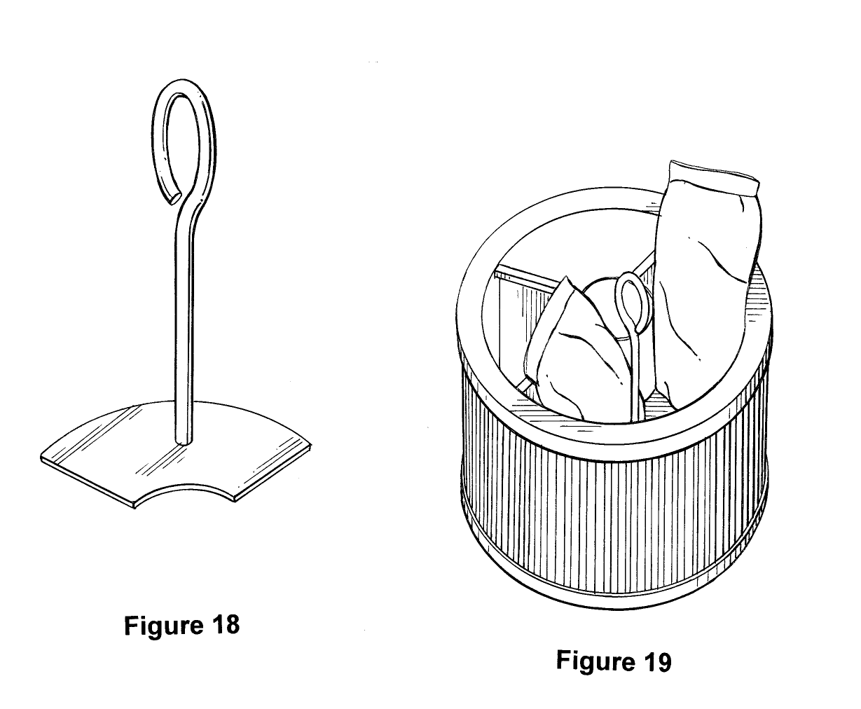

FIG. 18 illustrates a filter packet removal implement 300 that may advantageously be employed with the filter cartridge apparatus 100, 200 described above. In some embodiments, the implement 300 comprises a flat plate 302, preferable having a perimeter shaped to conform with the cross section of one of the compartments 136, 212. A handle 304 is attached at one end to the plate 302, and may advantageously terminate in a free end configured as a loop or eye 306 to facilitate being gripped by a hook or other tool (not shown), or directly by a user's hand.

FIG. 19 shows the use of the implement 300 in a filtration apparatus having a plurality of compartments 136, 212, as described above. The implement 300 is first installed in an empty compartment, with the plate 302 resting on the bottom of the compartment, and the handle 304 extending longitudinally out of the compartment. (At least one of the end caps 102, 114 would need to be configured to accommodate the handle 304.) After the implement 300 is so installed, a filter packet 152 is loaded in the compartment so as to be seated on the plate 302. When it is desired to unload or remove the filter packet 152 from the compartment, the implement 300 is pulled out of the compartment using the handle 304, thereby removing the packet 152 seated on the plate 302.

The illustrated embodiment of the implement 300 shows it to be configured to remove only a single packet 152 from a single compartment. Thus, a separate implement would need to be installed in each compartment, with the packets being removed one at a time. Modifications will readily suggest themselves, however, that would provide an implement configured to remove several packets from their respective compartments simultaneously. For example, a single handle can be attached (by suitably configured spokes, for example) to several plates, the plates being separated from each other by slots or gaps that accommodate the partitions 134.

The present embodiments provide numerous advantages. For example, the filter cartridge apparatus is readily disassembled. As discussed above, the end caps are removable from the cartridge assembly. By loosening the fastening members that secure the end caps to the partitions, one or both of the end caps may be removed. In certain embodiments, one of the end caps may be removable while the other end cap is secured to the assembly by more permanent means, such as welding. The removal of one or both end caps allows the pleated filter to be removed from the apparatus, rinsed, and later reused with the same filter cartridge apparatus, or replaced as necessary.

Because the filter cartridge apparatus is readily disassembled, the filter packets within the cartridge assembly are readily accessible. In those embodiments in which the filter medium is held within the filter packets, the filter medium is easily removable from the filter apparatus by removing the sealed filter packets, preferably and advantageously using the above-described filter packet removal implement. There is thus no need to dispose of the entire filter apparatus when the filter medium reaches the end of its usable life. Instead, when the filter medium becomes saturated with impurities such that it is no longer effective at filtering impurities from liquids and solvents, an operator can disassemble the filter cartridge apparatus by removing one of the end caps, removing the filter packets, adding a fresh set of filter packets, and reassembling the filter cartridge apparatus by reattaching the end cap. Since only the filter packets are replaced in this process, and not the entire filter cartridge apparatus, the present embodiments advantageously reduce operating costs.

The spent filter packets may, if desired, be placed in an evaporator to remove any liquids prior to disposing of the packets. Since hazardous waste disposal fees are usually calculated according to the weight of the substances being disposed of, evaporating the liquids from the filter packets prior to the disposal advantageously reduces disposal costs by reducing the weight of the spent filter packets, and allows for the reclamation and reuse of cleaning fluids that would normally be disposed of. Furthermore, because each of the filter packets is relatively small compared to the size of the overall filter cartridge apparatus, the packets are easier to fit in an evaporator. The present embodiments also reduce the total quantity of material that enters the waste stream, which reduces the environmental impact of disposing of spent filter media.

The components of the present apparatus for fluid filtration may be constructed of any suitable materials, such as one or more polymers or metals. For example, the end caps, the inner and outer partitions, and the radial partitions may be constructed of polymers or metals. Non-limiting examples of polymers from which the present apparatus may be constructed include nylon, polyethylene, polyurethane, ethylene-vinyl acetate (EVA), polyether block amide (PEBAX), acrylonitrile butadiene styrene (ABS), polyether ether ketone (PEEK), polytetrafluoroethylene (PTFE), thermoplastic polyetherimide (ULTEM), etc. Non-limiting examples of metals from which the present apparatus may be constructed include aluminum, steel, stainless steel, etc.

The above description presents various embodiments of the present disclosure, and the manner and process of making and using them, in such full, clear, concise, and exact terms as to enable any person skilled in the art to which it pertains to make and use this invention. The disclosed embodiments are, however, susceptible to modifications and alternate constructions from that discussed above that are fully equivalent. Consequently, this disclosure is not limited to the particular embodiments disclosed. On the contrary, this disclosure covers all modifications and alternate constructions coming within the spirit and scope of the disclosure as generally expressed by the following claims.

What is claimed is:

1. A fluid filtration cartridge assembly, comprising:
an outer mesh wall and an inner mesh wall defining a space therebetween;
a plurality of partitions extending between the outer wall and the inner wall, thereby dividing the space into a plurality of compartments;
a filter surrounding the outer mesh wall; and
a filter packet removal implement removably installed in at least one of the compartments, the filter packet removal implement including a plate disposed in the at least one compartment and a handle attached to the plate.

2. The assembly of claim 1, further comprising:
a filter packet located in the at least one compartment and seated on the plate when the filter packet removal implement is disposed in the at least one compartment.

3. The assembly of claim 2, wherein the filter packet contains a filter medium.

4. The assembly of claim 1, wherein the partitions extend radially between the inner and outer mesh walls so as to divide the space into a plurality of discrete longitudinal compartments.

5. The assembly of claim 4, wherein the at least one compartment has a cross-sectional shape, and wherein the plate has a perimeter configured to conform to the cross-sectional shape of the at least one compartment.

6. A method of loading a filter packet into a filter cartridge assembly and unloading the filter packet therefrom, the filter cartridge assembly having a plurality of filter packet compartments, the method comprising:
installing a plate with a handle attached thereto into at least one of the compartments;
loading a filter packet into the at least one compartment so as to be seated on the plate; and
using the handle, removing the plate with the filter packet seated thereon from the at least one compartment.

7. The method of claim 6, wherein the filter packet compartments are defined by a plurality of radial partitions within the filter cartridge assembly.

8. The method of claim 7, wherein the filter packet compartments extend longitudinally in the filter cartridge assembly.

9. The method of claim 6, wherein the at least one compartment has a cross-sectional shape, and wherein the plate has a perimeter configured to conform to the cross-sectional shape of the at least one compartment.
